(19) United States
(12) Patent Application Publication
(10) Pub. No.: US 2017/0146354 A1
(43) Pub. Date: May 25, 2017

(54) Electric Vehicle Exchange Management

(71) Applicant: International Business Machines Corporation, Armonk, NY (US)

(72) Inventors: Gregory J. Boss, Saginaw, MI (US); Rick A. Hamilton, II, Charlottesville, VA (US); James R. Kozloski, Fairfield, CT (US); Brian M. O'Connell, Cary, NC (US); Clifford A. Pickover, Yorktown Heights, NY (US)

(21) Appl. No.: 14/951,916

(22) Filed: Nov. 25, 2015

(51) Int. Cl. G01C 21/34; G06Q 30/06; B60L 11/18; G01S 19/38; G07C 5/00; G07C 5/08

(52) U.S. Cl. CPC G01C 21/3438; G01C 21/3446; G01C 21/3469; G07C 5/008; G07C 5/0866; B60L 11/1861; G01S 19/38; G06Q 30/0645

(57) ABSTRACT

Managing an electric vehicle exchange is provided. An available electric vehicle having a highest exchange score is selected to perform an exchange at a selected charging station with another electric vehicle that has an insufficient battery charge level to reach a travel destination of the another electric vehicle. In response to determining that a current battery charge level of the available electric vehicle is sufficient to reach the travel destination of the another electric vehicle, it is determined whether the exchange will allow the available electric vehicle to reach a travel destination of the available electric vehicle. In response to determining that the exchange will allow the available electric vehicle to reach the travel destination of the available electric vehicle, routing information is sent via a network to a navigation system of the available electric vehicle to the selected charging station.

### BACKGROUND

1. Field

The disclosure relates generally to electric vehicles and more specifically to managing an exchange of an electric vehicle having an insufficient battery charge to reach a user-desired destination with another electric vehicle that has sufficient battery charge to reach the user-desired destination.

2. Description of the Related Art

An electric vehicle, also referred to as an electric drive vehicle, uses one or more electric motors or traction motors for propulsion. Three main types of electric vehicles exist, those that are directly powered from an external power station, those that are powered by stored electricity originally from an external power source, and those that are powered by an on-board electrical generator, such as an engine (e.g., a hybrid electric vehicle), or a hydrogen fuel cell. A hybrid electric vehicle is a type of electric vehicle which combines a conventional internal combustion engine propulsion system with an electric propulsion system.

Typically, a single individual usually rents a rental vehicle from a rental company and that same individual must return that particular rental vehicle to the rental company. This may present a problem for renters when renting electronic vehicles that have limited travel range due to battery charge. Range, as is commonly referred to in electric vehicle literature, refers to the remaining distance an electric vehicle can travel with the amount of battery charge the electric vehicle currently has on board.

### SUMMARY

According to one illustrative embodiment of the present invention, a computer-implemented method for managing an electric vehicle exchange is provided. A computer selects an available electric vehicle having a highest exchange score to perform an exchange at a selected charging station with another electric vehicle that has an insufficient battery charge level to reach a travel destination of the another electric vehicle. In response to the computer determining that a current battery charge level of the available electric vehicle is sufficient to reach the travel destination of the another electric vehicle, the computer determines whether the exchange will allow the available electric vehicle to reach a travel destination of the available electric vehicle. In response to the computer determining that the exchange will allow the available electric vehicle to reach the travel destination of the available electric vehicle, the computer sends routing information via a network to a navigation system of the available electric vehicle to the selected charging station. According to other illustrative embodiments, a computer system and computer program product for managing an electric vehicle exchange are provided.

### BRIEF DESCRIPTION OF THE DRAWINGS

FIG. 1 is a pictorial representation of a network of data processing systems in which illustrative embodiments may be implemented;

FIGS. 2A-2B are a diagram of a data processing system in which illustrative embodiments may be implemented;

FIG. 3 is a diagram illustrating a cloud computing environment in which illustrative embodiments may be implemented;

FIG. 4 is a diagram illustrating an example of abstraction layers of a cloud computing environment in accordance with an illustrative embodiment;

FIG. 5 is a diagram of an example of an electric vehicle exchange management system in accordance with an illustrative embodiment;

FIG. 6 is a diagram of example fractal quick response codes in accordance with an illustrative embodiment;

FIG. 7 is a flowchart illustrating a process for determining whether a travel destination of an electric vehicle exceeds a travel distance of the electric vehicle at a current battery level charge of the electric vehicle in accordance with an illustrative embodiment;

FIG. 8 is a flowchart illustrating a process for selecting an available electric vehicle to exchange with an electric vehicle having insufficient battery charge to reach its destination in accordance with an illustrative embodiment; and

FIG. 9 is a flowchart illustrating a process for identifying damage to an electric vehicle prior to an exchange in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

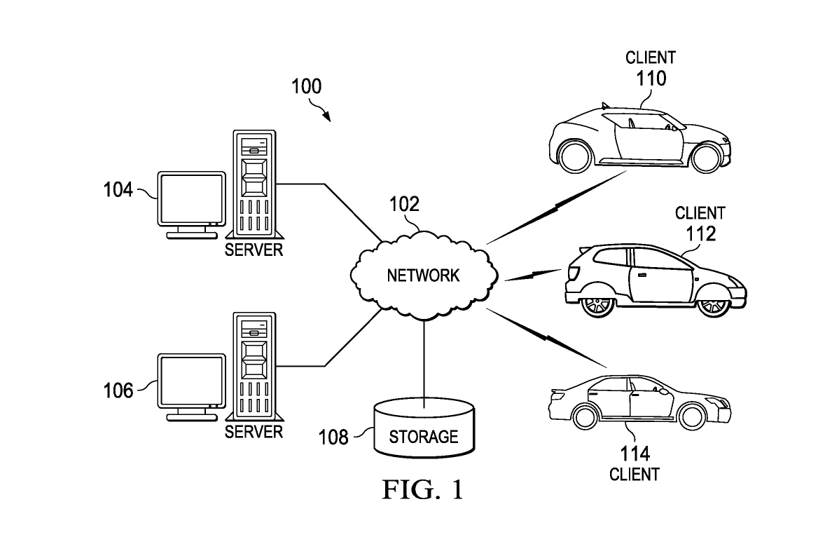

With reference now to the figures, and in particular, with reference to FIGS. 1-5, diagrams of data processing environments are provided in which illustrative embodiments may be implemented. It should be appreciated that FIGS. 1-5 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and the other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide a set of services, such as, for example, an electric vehicle exchange service that manages exchange of electric vehicles or electric vehicle batteries for electric vehicles that have insufficient battery charge level to reach their respective travel destinations.

Client 110, client 112, and client 114 also connect to network 102. Clients 110, 112, and 114 represent electric vehicles that include onboard data processing systems, which are registered clients of the electric vehicle exchange service provided by server 104 and server 106. The electric vehicles may be any type of electric vehicle, such as, for example, cars, vans, sport utility vehicles, trucks, semi-tractors, tractors, and the like. Further, the electric vehicles may include, for example, manned electric vehicles, which may include semi-autonomous electric vehicles that may or may not require human intervention, and unmanned electric vehicles, which do not require human intervention.

However, it should be noted that clients 110, 112, and 114 are intended as examples only. In other words, clients 110, 112, and 114 may represent other types of data processing systems. For example, clients 110, 112, and 114 may be registered data processing systems, such as, for example, laptop computers, tablet computers, handheld computers, smart phones, smart watches, personal digital assistants, gaming devices, and the like, which users of electric vehicles utilize to wirelessly connect to the electric vehicle exchange service provided by server 104 and server 106 via network 102 while utilizing the electric vehicles. Further, server 104 and server 106 also may provide information, such as boot files, operating system images, software applications, maps, routing data, and notifications to clients 110, 112, and 114.

Storage 108 is a network storage device capable of storing any type of data in a structured format or an unstructured format. Data stored in storage 108 may include, for example, electric vehicle exchange managers, list of registered electric vehicles with respective specification information, list of charging stations with locations and available services, and list of registered electric vehicle users with identification information. Further, storage unit 108 may store other types of data, such as authentication or credential data that may include user names, passwords, and biometric data associated with system administrators and users.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to a data processing system of client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example only, and not as an architectural limitation for the different illustrative embodiments.

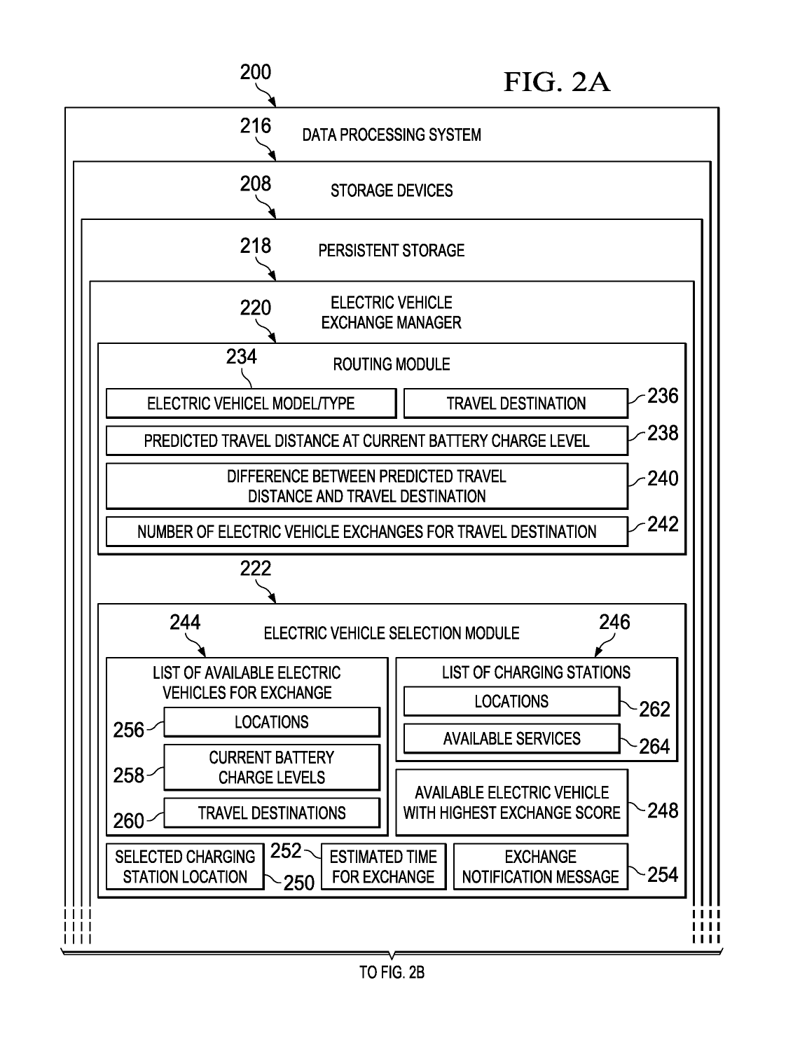

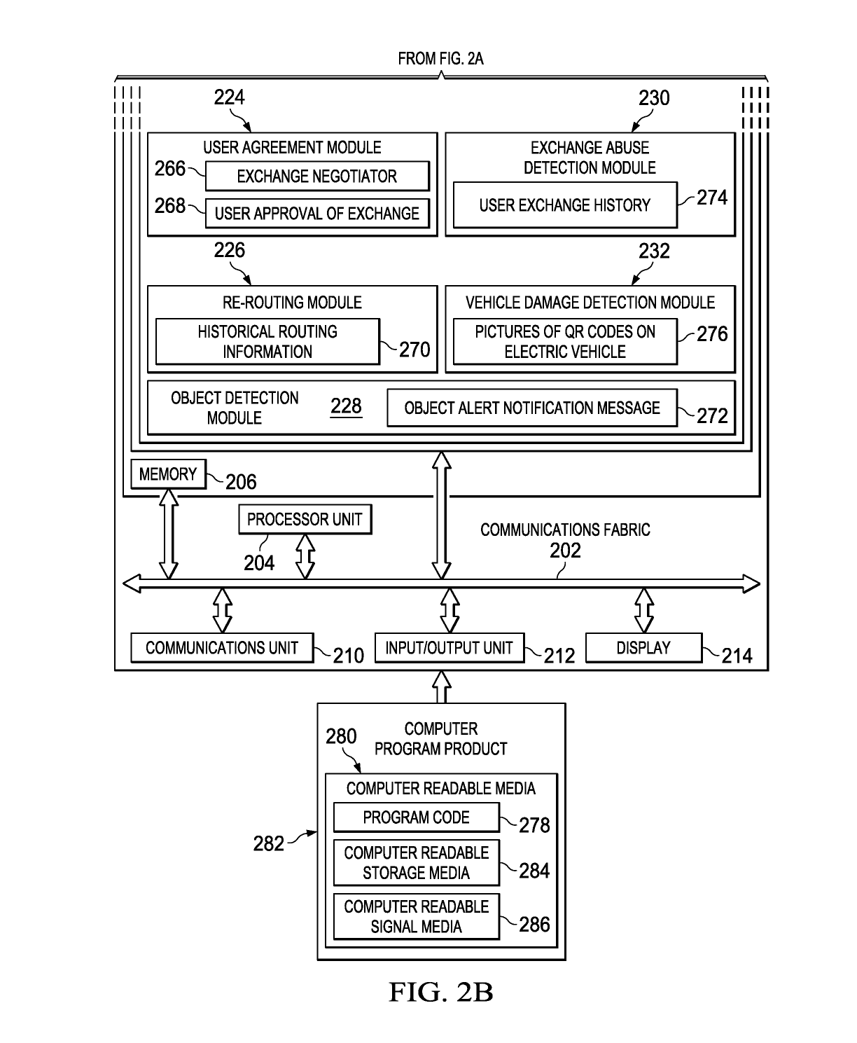

With reference now to FIGS. 2A-2B, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores electric vehicle exchange manager 218. Electric vehicle exchange manager 218 monitors the current battery charge levels of registered electric vehicles and controls the exchange of an electric vehicle having an insufficient battery charge to reach a desired travel destination of a user of the electric vehicle with another electric vehicle that has sufficient battery charge to reach the user's desired travel destination. The exchange may either be an exchange of the electric vehicles, themselves, or an exchange of batteries between the electric vehicles.

In this example, electric vehicle exchange manager 218 includes routing module 220, electric vehicle selection module 222, user agreement module 224, re-routing module 226, object detection module 228, exchange abuse detection module 230, and vehicle damage detection module 232. However, it should be noted that electric vehicle exchange manager 218 may include more or less modules. For example, two or more of the modules may be combined into one module or one module may be separated into two or more modules. Vehicle exchange manager 218 also may include modules not shown.

Routing module 220 includes electric vehicle model/type 234, travel destination 236, predicted travel distance at current battery charge level 238, difference between predicted travel distance and travel destination 240, and number of electric vehicle exchanges for travel destination 242. Electric vehicle model/type 234 includes data regarding a particular electric vehicle, such as the make and model of the electric vehicle, identification number, weight, battery type and storage capacity, mileage, onboard data processing and/or navigation system identifiers, and the like. Routing module 220 may receive electric vehicle model/type 234 from, for example, an electric vehicle rental service system and/or a manufacturer of the electric vehicle.

Routing module 220 may receive travel destination 236 from a user of the electric vehicle via, for example, a navigation system of the electric vehicle. Alternatively, routing module 220 may receive travel destination 236 from a data processing system, such as a smart phone, utilized by the user of the electric vehicle. Travel destination 236 is the desired final destination of the user's travel plans. Based on travel destination 236, routing module 220 determines the total travel distance. In addition, routing module 220 calculates predicted travel distance at current battery charge level 238 and difference between predicted travel distance and travel destination 240. If routing module 220 determines that the predicted travel distance is greater than the vehicle range at the current battery charge level, then routing module 220 determines that the user of the electric vehicle is eligible for an electric vehicle exchange at a location which is selected by routing module 220.

The user may manually enter the route of travel to travel destination 236 using, for example, the electric vehicle's satellite navigation system. Alternatively, routing module 220 may automatically estimate the route in real time using GPS localization and a Bayesian model of routes that the user is likely to take given the user's current context and location and what travel routes other users have previously taken to reach travel destination 236. Routing module 220 then makes an initial calculation as to whether or not the electric vehicle has sufficient charge to achieve the predicted range. If routing module 220 later detects that the electric vehicle will not make it to the desired destination due to stop-and-go traffic, for example, then routing module 220 may re-route the user to a location to perform an electric vehicle exchange with another user of a different electric vehicle. It should be noted that this location for the exchange is called a “charging station” even though a traditional electric vehicle battery charging device may not be present at that location.

Further, routing module 220 also may calculate number of electric vehicle exchanges for travel destination 242. In other words, travel destination 236 may require the user to perform more than one electric vehicle exchange prior to reaching travel destination 236.

Similarly, electric vehicle exchange manager 218 utilizes electric vehicle selection module 222 to find the second electric vehicle, which has more range than required to complete a trip of the user of the second electric vehicle, for performing the exchange. Illustrative embodiments may provide some benefit to the user of the second electric vehicle for meeting the user of the first electric vehicle at a selected charging station and time. This benefit may be in the form of a discounted price on a future electric vehicle rental or avoidance of a penalty that illustrative embodiments may impose whenever an electric vehicle user fails to meet some minimum number of required exchanges on the user's trip or when the user returns the electric vehicle with too much battery charge remaining.

Electric vehicle selection module 222 includes list of available electric vehicles for exchange 244, list of charging stations 246, available electric vehicle with highest exchange score 248, selected charging station location 250, estimated time for exchange 252, and exchange notification message 254. List of available electric vehicles for exchange 244 includes locations 256, current battery charge levels 258, and travel destinations 260. Locations 256, current battery charge levels 258, and travel destinations 260 represent the locations, current battery charge levels, and travel destinations of each respective electric vehicle in list of available electric vehicles for exchange 244. List of charging stations 246 includes locations 262 and available services 264. Locations 262 and available services 264 represent the locations and available services of each respective charging station in list of charging stations 246. Available services 264 are the services, such as an electric vehicle battery charger service, food service, security service, and the like, which may be available at a particular charging station.

Electric vehicle selection module 222 detects which electric vehicles, which may be currently on the road or in a parking lot, that are potential candidates for routing to a charging station for an electric vehicle exchange. Optimal electric vehicle selection may consist of a number of parameters that may be combined to determine the best electric vehicle for performing the exchange. The parameters that electric vehicle selection module 222 may take into account are, for example: 1) proximity of available electric vehicles to the electric vehicle requiring the exchange; 2) opposite inverse relationships between range available and distance to go to reach respective travel destinations; 3) estimated length of time to perform exchange (e.g., electric vehicle selection module 222 may make this estimation based on an automatic detection of objects in the electric vehicle corresponding to the original user using weight sensors/pressure sensor mats in the trunk, seats, and floorboards of the electric vehicle. Electric vehicles with fewer and lighter objects are more optimal selections than other electric vehicles with more and heavier objects, which may make the exchange more difficult and time consuming.); and 4) each user's route to a travel destination and estimated return time also may be used by electric vehicle selection module 222 to determine the optimal electric vehicle for exchange (e.g., if the user has programmed his destination route along with stop times, electric vehicle selection module 222 may determine that the user will be back in a short period of time and will need the remaining battery charge of the user's current electric vehicle to make it to the next destination. In such a scenario, electric vehicle selection module 222 should not propose an exchange for that particular electric vehicle, as it may impede that user's travel plans.

Electric vehicle selection module 222 may further use an iterative loop over a network incorporating these parameters to perform this determination of the optimal electric vehicle for exchange. The network may parameterize electric vehicle links (i.e., edges) with exchange scores between the various electric vehicles (i.e., nodes), and may insert these electric vehicle nodes and parameterized edges between nodes into a data space of travel destinations for an order embedding algorithm for nonlinear dimensionality reduction. Examples of an order embedding algorithm include an elastic map, a Sammon's map, a Kohonen map, or a combination thereof. Next, the network may associate association linkages between an electric vehicle and at least one pair of data points in the data space, each association link representing different candidate geographic locations of electric vehicle exchange or of travel destinations, and each association link representing a risk of the electric vehicle running out of charge before arrival at one candidate geographic location of electric vehicle exchange in the order embedding algorithm. The network may compute a total energy of the order embedding algorithm. For example, the network may compute the total energy as a sum of an approximation energy related to the association links and distortion energy of the network.

Based on the computed total energy being greater than a set total energy threshold, the network may: i) re-associate one or more of the electric vehicle links between a previously unassociated pair of electric vehicles; ii) re-associate one or more of the association links to a previously associated pair of the candidate geographic locations of electric vehicle exchange in the data space between a previously unassociated pair of candidate geographic locations of electric vehicle exchange; or iii) both. The iterative loop as outlined above in the previous paragraph is repeated. In one example, the re-associating automatically re-associates the association link between a previously unassociated pair of the data points in the data space and a component in response to the re-association resulting in lower total energy.

Electric vehicle selection module 222 makes these determinations by computing a function of the parameters above and producing an exchange score for each available electric vehicle. The electric vehicle with the highest exchange score (i.e., highest desirability for the exchange) is then selected and an exchange proposal initiated by electric vehicle selection module 222. The initiation of the exchange requires electric vehicle selection module 222 sending exchange notification message 254 to the user of the selected electric vehicle, which has more range than is needed to reach the user's destination, along with appropriate highlighted benefits for the user. Exchange notification message 254 may be via onboard audio, video, or communication device.

It should be noted that if a multitude of electric vehicles were to implement illustrative embodiments, then an optimal redistribution of charge/batteries may result. However, to minimize the number of electric vehicle exchanges, a central initiator, such as, for example, a cloud-based electric vehicle rental service, may be required. However, it should be noted that the process of illustrative embodiments may be preformed entirely on the electric vehicle, itself, or remotely on a network server.

Electric vehicle exchange manager 218 utilizes user agreement module 224 to negotiate the terms of an exchange proposal. User agreement module 224 includes exchange negotiator 266 which automatically negotiates exchange arrangements with the electric vehicle users. Exchange arrangements may include, for example, time and location of the exchange. If a user of an available electric vehicle agrees to perform an electric vehicle exchange with a user of an electric vehicle with insufficient battery charge to reach a desired destination, then user agreement module 224 notifies the user of the electric vehicle with insufficient battery charge and requests approve of the vehicle exchange, such as user approval of exchange 268. User agreement module 224 may provide the user of the available electric vehicle that agreed to the electric vehicle exchange with a discounted price on a future electric vehicle rental, for example.

Electric vehicle exchange manager 218 utilizes re-routing module 226 to ensure that each electric vehicle involved in an exchange arrives at the charging station, without either user getting lost or arriving late, once the exchange proposal is accepted by all electric vehicle users involved in the exchange. Re-routing module 226 may make use of a service upload to personal handheld smart phones or head-mounted displays of the electric vehicle users or to onboard data processing devices of the electric vehicle. This just-in-time delivering of directions and reprogramming of the navigation system of the electric vehicles may allow the users of the electric vehicles to not be cognitively taxed by the exchange. Re-routing module 226 may utilize historical routing information 270 for determining the best time, route, and location for performing the exchange.

Electric vehicle exchange manager 218 may utilize object detection module 228 to estimate the length of time to perform an electric vehicle exchange. Object detection module 228 identifies and enumerates objects onboard each electric vehicle involved in the exchange. This identification and enumeration of objects helps electric vehicle exchange manager 218 to estimate how long it will take to unload the objects from one electric vehicle and reload the objects into another electric vehicle. In addition, this identification and enumeration of objects also may help electric vehicle exchange manager 218 to identify whether any objects were left in a previous electric vehicle during the exchange at a charging station. Automated object detection may include, for example, sensor detection of a change of weight, which may include an overall electric vehicle weight, seat weight, and trunk weight, and image detection of objects to ensure that no object is left in a vehicle. If object detection module 228 detects that a user has left behind an object in an electric vehicle, then object detection module 228 sends object alert notification message 272 to the user when the user enters the waiting electric vehicle involved in the exchange.

Electric vehicle exchange manager 218 may utilize exchange abuse detection module 230 to detect which users perform electric vehicle exchanges too frequently such that these users abuse this electric vehicle exchange system by not renting the appropriate electric vehicle. For example, it may be cheaper for a user to rent an electric vehicle with a lower range and then keep exchanging vehicles. However, such use of the electric vehicle exchange system may not be optimal for the electric vehicle rental service. As such, exchange abuse detection module 230 may track user exchange behavior in user exchange history 274 and may require users that exceed a certain number of exchanges to pay a premium or higher electric vehicle rental price.

Electric vehicle exchange manager 218 may utilize vehicle damage detection module 232 to detect any damage to an electric vehicle prior to authorizing an exchange of electric vehicles by users. In general, a user of an electric vehicle is responsible for any damage to the rented electric vehicle while the user is in possession of the electric vehicle. Disagreements between users may occur over who caused damage to a particular electric vehicle when electric vehicles have been exchanged between the users. To prevent such disagreements, a charging station may be equipped with an imaging system, such as a set of still picture cameras and/or video cameras, which can capture images of all angles of the electric vehicle in question. Prior to authorizing an electric vehicle exchange operation, vehicle damage detection module 232 may instruct the imaging system to capture a set of pictures and/or a videos that shows every angle of each electric vehicle involved in the exchanged.

All electric vehicles registered with this electric vehicle exchange system will have quick response codes imprinted or painted onto a set of parts or panels of the electric vehicles or printed on stickers or silk screens that are placed on the set of parts or panels of the electric vehicles. Using the images provided by the imaging system that capture the quick response codes on the electric vehicles, vehicle damage detection module 232 may use the captured quick response codes to identify each part/panel of the electric vehicles, associate each image with each part/panel, and identify damage prior to the exchange. If an imaging system is not available at the selected charging station, then vehicle damage detection module 232 may instruct the users to take pictures or videos of the electric vehicles using their smart phones, for example. Vehicle damage detection module 232 will not authorize an electric vehicle exchange until all angles and quick response codes of the electric vehicles are captured and recorded, such as pictures of quick response codes on electric vehicles 276.

In the illustrative embodiment where the users of the electric vehicles involved in the exchange only exchange batteries rather than exchanging the electric vehicles, themselves, these electric vehicles may be equipped with multiple battery systems. One battery system may be permanent for the electric vehicle and another battery system may be exchangeable. The permanent battery system may be mounted somewhere inaccessible, but optimal for vehicle weight distribution, whereas the exchangeable battery system may be easily accessible.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user, such as a system administrator, and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 278 is located in a functional form on computer readable media 280 that is selectively removable and may be loaded onto or transferred to data processing system 200 for running by processor unit 204. Program code 278 and computer readable media 280 form computer program product 282. In one example, computer readable media 280 may be computer readable storage media 284 or computer readable signal media 286. Computer readable storage media 284 may include, for example, an optical or magnetic disc that is inserted or placed into a drive or other device that is part of persistent storage 208 for transfer onto a storage device, such as a hard drive, that is part of persistent storage 208. Computer readable storage media 284 also may take the form of a persistent storage, such as a hard drive, a thumb drive, or a flash memory that is connected to data processing system 200. In some instances, computer readable storage media 284 may not be removable from data processing system 200.

Alternatively, program code 278 may be transferred to data processing system 200 using computer readable signal media 286. Computer readable signal media 286 may be, for example, a propagated data signal containing program code 278. For example, computer readable signal media 286 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 278 may be downloaded over a network to persistent storage 208 from another device or data processing system through computer readable signal media 286 for use within data processing system 200. For instance, program code stored in a computer readable storage media in a data processing system may be downloaded over a network from the data processing system to data processing system 200. The data processing system providing program code 278 may be a server computer, a client computer, or some other device capable of storing and transmitting program code 278.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIGS. 2A-2B can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 284 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

It should be understood that although this disclosure includes a detailed description on cloud computing, implementation of the teachings recited herein are not limited to a cloud computing environment. Rather, illustrative embodiments are capable of being implemented in conjunction with any other type of computing environment now known or later developed. Cloud computing is a model of service delivery for enabling convenient, on-demand network access to a shared pool of configurable computing resources, such as, for example, networks, network bandwidth, servers, processing, memory, storage, applications, virtual machines, and services, which can be rapidly provisioned and released with minimal management effort or interaction with a provider of the service. This cloud model may include at least five characteristics, at least three service models, and at least four deployment models.

The characteristics may include, for example, on-demand self-service, broad network access, resource pooling, rapid elasticity, and measured service. On-demand self-service allows a cloud consumer to unilaterally provision computing capabilities, such as server time and network storage, as needed automatically without requiring human interaction with the provider of the service. Broad network access provides for capabilities that are available over a network and accessed through standard mechanisms, which promotes use by heterogeneous thin or thick client platforms, such as, for example, mobile phones, laptops, and personal digital assistants. Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction, such as, for example, country, state, or data center. Rapid elasticity provides for capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. Measured service allows cloud systems to automatically control and optimize resource use by leveraging a metering capability at some level of abstraction appropriate to the type of service, such as, for example, storage, processing, bandwidth, and active user accounts. Resource usage can be monitored, controlled, and reported providing transparency for both the provider and consumer of the utilized service.

Service models may include, for example, Software as a Service (SaaS), Platform as a Service (PaaS), and Infrastructure as a Service (IaaS). Software as a Service is the capability provided to the consumer to use the provider's applications running on a cloud infrastructure. The applications are accessible from various client devices through a thin client interface, such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service is the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service is the capability provided to the consumer to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components, such as, for example, host firewalls.

Deployment models may include, for example, a private cloud, community cloud, public cloud, and hybrid cloud. A private cloud is a cloud infrastructure operated solely for an organization. The private cloud may be managed by the organization or a third party and may exist on-premises or off-premises. A community cloud is a cloud infrastructure shared by several organizations and supports a specific community that has shared concerns, such as, for example, mission, security requirements, policy, and compliance considerations. The community cloud may be managed by the organizations or a third party and may exist on-premises or off-premises. A public cloud is a cloud infrastructure made available to the general public or a large industry group and is owned by an organization selling cloud services. A hybrid cloud is a cloud infrastructure composed of two or more clouds, such as, for example, private, community, and public clouds, which remain as unique entities, but are bound together by standardized or proprietary technology that enables data and application portability, such as, for example, cloud bursting for load-balancing between clouds.

A cloud computing environment is service oriented with a focus on statelessness, low coupling, modularity, and semantic interoperability. At the heart of cloud computing is an infrastructure comprising a network of interconnected nodes.

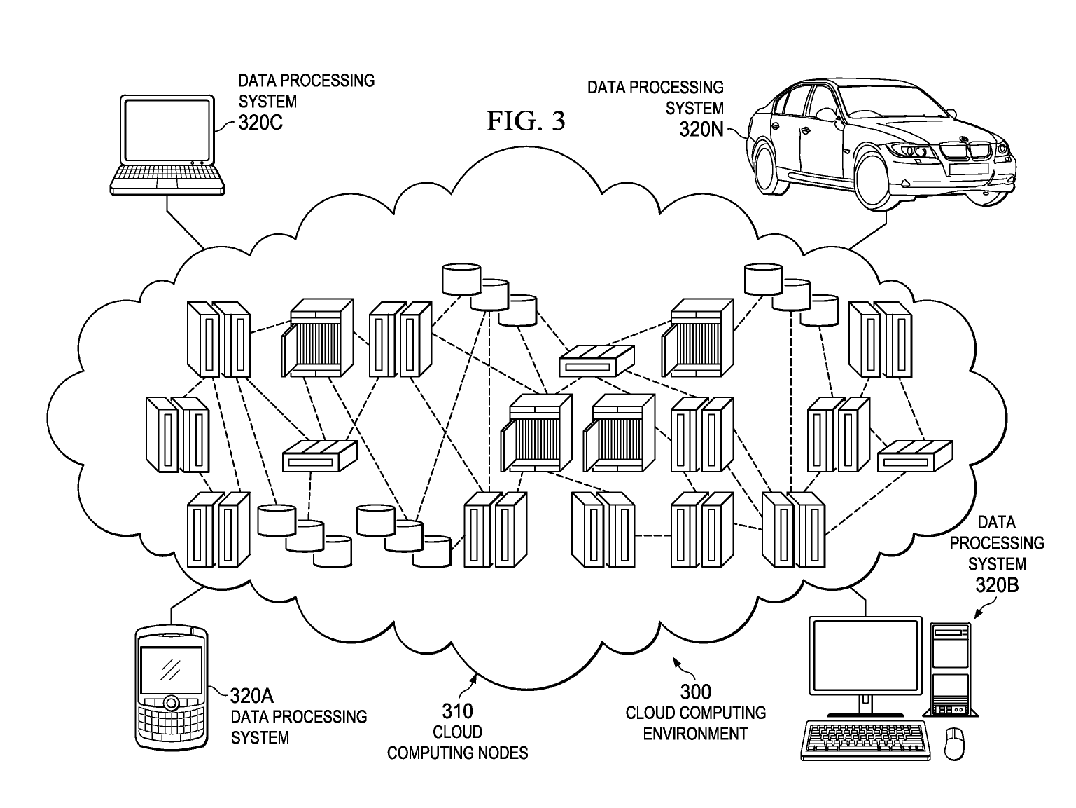

With reference now to FIG. 3, a diagram illustrating a cloud computing environment is depicted in which illustrative embodiments may be implemented. In this illustrative example, cloud computing environment 300 includes a set of one or more cloud computing nodes 310 with which local data processing systems used by cloud consumers may communicate. Cloud computing nodes 310 may be, for example, server 104 and server 106 in FIG. 1. Local data processing systems that communicate with cloud computing nodes 310 include data processing system 320A, which may be a personal digital assistant or a smart phone, data processing system 320B, which may be a desktop computer or a network computer, data processing system 320C, which may be a laptop computer, and data processing system 320N, which may be a computer system of an automobile. Data processing systems 320A-320N may be, for example, clients 110-114 in FIG. 1.

Cloud computing nodes 310 may communicate with one another and may be grouped physically or virtually into one or more cloud computing networks, such as a private cloud computing network, a community cloud computing network, a public cloud computing network, or a hybrid cloud computing network. This allows cloud computing environment 300 to offer infrastructure, platforms, and/or software as services without requiring the cloud consumers to maintain these resources on their local data processing systems, such as data processing systems 320A-320N. It is understood that the types of data processing devices 320A-320N are intended to be examples only and that cloud computing nodes 310 and cloud computing environment 300 can communicate with any type of computerized device over any type of network and/or network addressable connection using a web browser, for example.

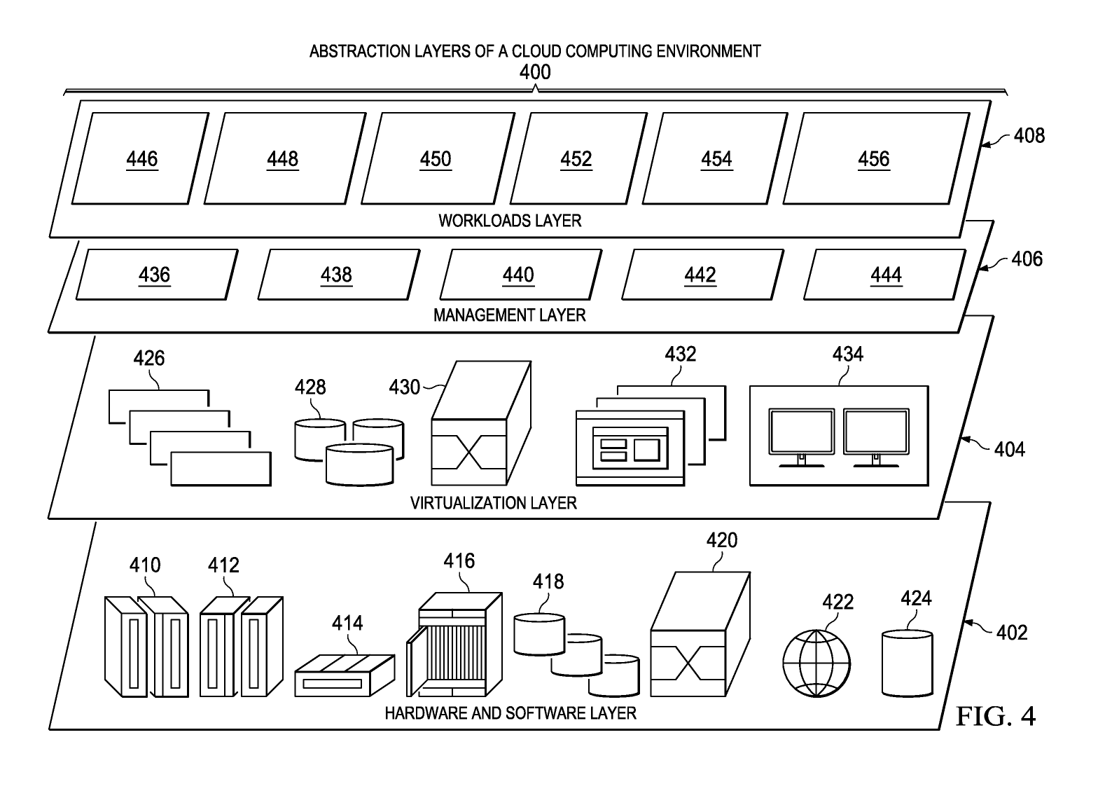

With reference now to FIG. 4, a diagram illustrating an example of abstraction layers of a cloud computing environment is depicted in accordance with an illustrative embodiment. The set of functional abstraction layers shown in this illustrative example may be implemented in a cloud computing environment, such as cloud computing environment 300 in FIG. 3. Also, it should be noted that the layers, components, and functions shown in FIG. 4 are intended to be examples only and not intended to be limitations on illustrative embodiments.

In this example, abstraction layers of a cloud computing environment 400 includes hardware and software layer 402, virtualization layer 404, management layer 406, and workloads layer 408. Hardware and software layer 402 includes the hardware and software components of the cloud computing environment. The hardware components may include, for example, mainframes 410, RISC (Reduced Instruction Set Computer) architecture-based servers 412, servers 414, blade servers 416, storage devices 418, and networks and networking components 420. In some illustrative embodiments, software components may include, for example, network application server software 422 and database software 424.

Virtualization layer 404 provides an abstraction layer from which the following examples of virtual entities may be provided: virtual servers 426; virtual storage 428; virtual networks 430 including virtual private networks; virtual applications and operating systems 432; and virtual machines 434.

Management layer 406 may provide a plurality of different management functions, such as, for example, resource provisioning 436, metering and pricing 438, security and user portal 440, service level management 442, and electric vehicle management 444. Resource provisioning 436 dynamically procures computing resources and other resources, which are utilized to perform workloads or tasks within the cloud computing environment. Metering and pricing 438 provides cost tracking as resources are utilized within the cloud computing environment and billing for consumption of these resources. In one example, these resources may comprise application software licenses. Security of security and user portal 440 provides identity verification for cloud consumers and workloads, as well as protection for data and other resources. User portal of security and user portal 440 provides access to the cloud computing environment for cloud consumers and system administrators. Service level management 442 provides cloud computing resource allocation and management such that required service levels are met based on service level agreements. Electric vehicle management 444 provides management of exchanging electric vehicles or electric vehicle batteries when a current battery charge level of an electric vehicle is not sufficient for the electric vehicle to reach a user desired destination.

Workloads layer 408 provides the functionality of the cloud computing environment. Example workloads and functions provided by workload layer 408 may include mapping and navigation 446, software development and lifecycle management 448, virtual classroom education delivery 450, data analytics processing 452, transaction processing 454, and managing electric vehicle exchanges 456.

In the course of developing illustrative embodiments, it was discovered that a way is needed to permit drivers to seamlessly exchange rental electric vehicles based on user-desired distance to travel and electric vehicle range. Illustrative embodiments employ a rental car company model that maximizes “charge on road” by rewarding users who return their electric vehicles fully depleted of battery charge. In this way, illustrative embodiments provide users of electric vehicles more assurance that the users will reach their respective travel destinations without having to delay and wait for battery recharging. Illustrative embodiments accomplish this by automatic orchestration of electric vehicle exchanges.

Illustrative embodiments ensure a useful exchange of electric vehicles, which is beneficial for both rental parties involved in the exchange and the electric vehicle rental service. One illustrative embodiment comprises a process of electric vehicle battery exchange that includes, for example: 1) having rental electric vehicles with the capability for battery exchange; 2) determining the expected distance remaining to be traveled by the users before returning each respective electric vehicle; 3) determining the expected remaining range of each respective electric vehicle; 4) determining whether the expected distances and ranges are positively or inversely correlated for each user's electric vehicle; and 5) initiating an exchange of batteries between the electric vehicles by the users based on the determining steps.

Another illustrative embodiment comprises a process of exchanging electric vehicle that includes, for example: 1) having electric vehicles for rent; 2) determining the expected distance remaining to be traveled by the users before returning each respective electric vehicle; 3) determining the expected remaining range of each respective electric vehicle; 4) determining whether the expected distances and ranges are positively or inversely correlated for each user's electric vehicle; and 5) initiating the exchange of the electric vehicles, themselves, by the users based on the determining steps.

Also, illustrative embodiments may utilize a vehicle damage module in which the vehicle damage module utilizes images of fractal quick response codes located on registered electric vehicles to facilitate identification of vehicle damage and to facilitate exchange of the electric vehicles. In addition, illustrative embodiments may utilize vehicle weight determination or automatic detection of personal objects/items to facilitate the electric vehicle exchange. Further, illustrative embodiments may utilize a routing module to determine a battery exchange location or an electric vehicle exchange location as the location is parameterized by the electric vehicle rental service. The user may manually enter the travel route using the electric vehicle's navigation system, for example. Alternatively, the routing module may automatically estimate the travel route in real time based on GPS localization and a Bayesian model of travel routes that the user is likely to take given the user's current context and location and what travel routes other users have previously taken to a particular destination.

Electric vehicles have a specified travel range after which the electric vehicles must be recharged. If multiple electric vehicles are at a particular charging station and a user needs to reach a destination outside the range of the user's current electric vehicle, then illustrative embodiments allow that user to perform an electric vehicle exchange with another user of a different electric vehicle. Illustrative embodiments ensure a fair exchange that is beneficial for both rental parties and the rental service.

As a result, illustrative embodiments may: 1) increase marketability of electronic vehicle rentals; 2) enable users to not wait for battery recharging; 3) ensure electric vehicle batteries enter deep draw-down before recharging; and 4) increase the chances that users may access battery charge even when the nearest rental service or charging station is far away. Consequently, rental electric vehicles may become fungible in that a user may exchange the user's electric vehicle and make use of another rental electric vehicle with similar characteristics, such as, for example, same type/model and/or same type of battery, that still has remaining battery charge to reach a desired travel destination.

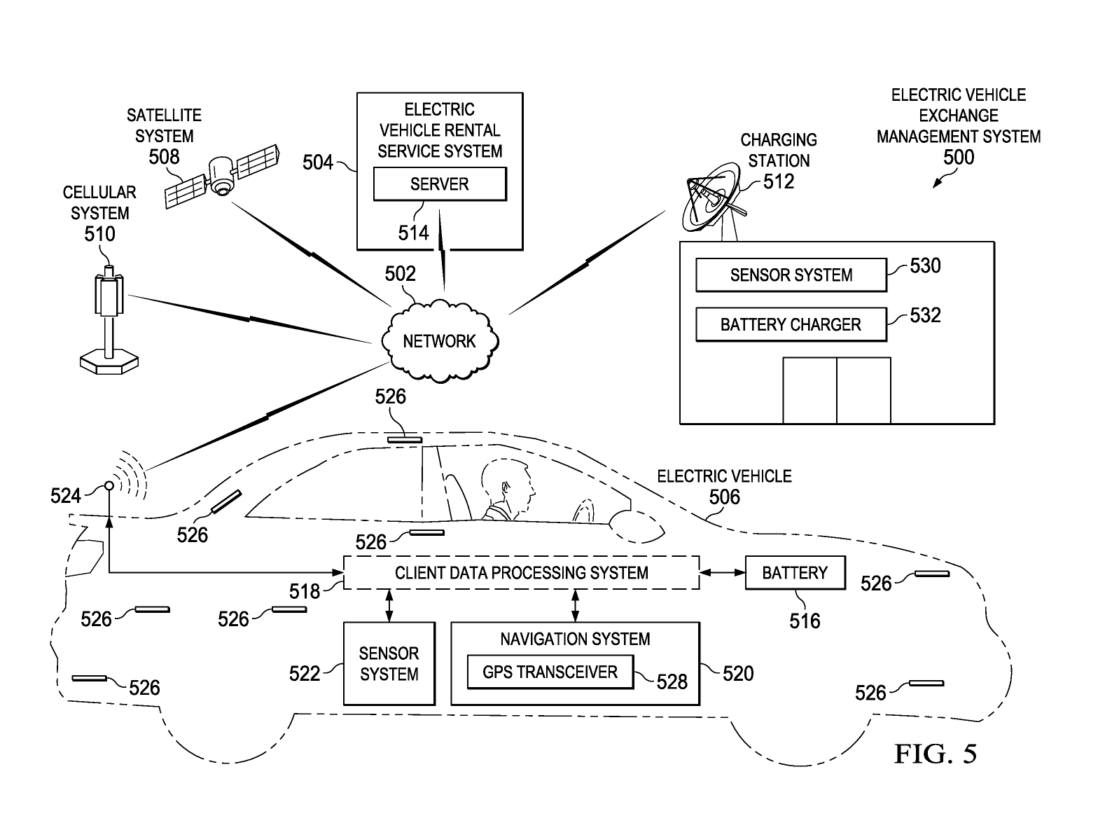

With reference now to FIG. 5, a diagram of an example of an electric vehicle exchange management system is depicted in accordance with an illustrative embodiment. Electric vehicle exchange management system 500 monitors and controls the exchange of electric vehicles or electric vehicle batteries in order for users of the electric vehicles, which have limited range due to insufficient battery charge, to reach their desired destinations. Electric vehicle exchange management system 500 may be implemented in a network of data processing systems, such as network data processing system 100 in FIG. 1, or in a cloud computing environment, such as cloud computing environment 300 in FIG. 3.

In this example, electric vehicle exchange management system 500 includes network 502, electric vehicle rental service system 504, electric vehicle 506, satellite system 508, cellular system 510, and charging station 512. Network 502 may be, for example, network 102 in FIG. 1. Network 502 provides communication between the different systems of electric vehicle exchange management system 500.

Electric vehicle rental service system 504 manages and controls the rental of and the exchanges of electric vehicles, such as electric vehicle 506. Electric vehicle rental service system 504 includes server 514. Server 514 may be, for example, server 104 in FIG. 1 and data processing system 200 in FIGS. 2A-2B. Server 514 provides the data processing capabilities of electric vehicle rental service system 504. Server 514 may represent a plurality of server computers connected to network 502.

Electric vehicle 506 may be, for example, client 110 in FIG. 1. Electric vehicle 506 includes battery 516, client data processing system 518, navigation system 520, sensor system 522, antenna 524, and quick response codes 526. Battery 516 provides the stored energy to propel electric vehicle 506. Battery 516 may be, for example, an exchangeable battery, which may be easily transferred from one electric vehicle to another electric vehicle.

Client data processing system 518 may be, for example, data processing system 320N in FIG. 3. Client data processing system 518 is a client of server 514. Client data processing system 518 provides the data processing capabilities of electric vehicle 506 and is coupled to battery 516, navigation system 520, sensor system 522, and antenna 524.

Navigation system 520 includes GPS transceiver 528. GPS transceiver 528 provides geo-location coordinates for identification of the current location of electric vehicle 506. A user of electric vehicle 506 may manually enter a travel destination and travel route in navigation system 520. Navigation system 520 may communicate the geo-location coordinates, travel destination, and travel route information to server 514 via network 502.

Sensor system 522 may include, for example, weight and/or pressure sensors to detect objects within electric vehicle 506. In addition, sensor system 522 may include a set of one or more imaging devices, such as a set of cameras, to take images of the interior of electric vehicle 506 to detect objects within electric vehicle 506. Further, sensor system 522 may include a battery charge sensor that is capable of determining the current battery charge level of battery 516. Sensor system 522 may communicate this sensor data to server 514 via network 502 as well.

Electric vehicle 506 may use antenna 524 to send data to and receive data from electric vehicle rental service system 504, satellite system 508, cellular system 510, and charging station 512. Even though antenna 524 is depicted as an external antenna in this example, antenna 524 may be an internal antenna located in, for example, a communication unit within client data processing system 518. Further, it should be noted that any form of wireless communication, such as, for example, radio transmission, microwave transmission, cellular telephone transmission, wireless Web transmission, wireless fidelity (Wi-Fi) transmission, Bluetooth transmission, or any combination thereof, may be employed for communication purposes within and between the different components comprising electric vehicle exchange management system 500.

Quick response codes 526 represent a plurality of quick response codes located on electric vehicle 506. A quick response code is a type of two-dimensional barcode that is a machine-readable optical label containing information about the item to which the quick response code is attached. A quick response code consists of square dots arranged in a square grid, which can be read by an imaging device, such as a camera. One quick response code in quick response codes 526 is located on a particular part of electric vehicle 506 for identification of the particular part and for possibly identifying any damage to that particular part. In addition, quick response codes in quick response codes 526 may be different sizes. Further, quick response codes in quick response codes 526 may be fractal quick response codes that occur at progressively smaller scales.

Each quick response code may be imprinted on a part of electric vehicle 506 (e.g., painted on a part of electric vehicle 506, applied with a large sticker, applied in an “invisible fashion” until ultraviolet light is applied, et cetera). If damage occurs to electric vehicle 506 or if dirt is present on electric vehicle 506, then one or more of quick response codes 526 may be obscured and size aspects of the damage and/or dirt may be gleaned from an analysis of the obscuration as a function of a quick response code array size. Illustrative embodiments preferably utilize quick response codes because the quick response codes are able to do “double duty” (i.e., identify a particular part and provide scaling (size) information about damage and dirt). However, it should be noted that illustrative embodiments are not limited to the use of quick response codes. For example, an alternative illustrative embodiment may utilize radio-frequency identification (RFID) tags.

Satellite system 508 may be, for example, a network of global positioning system (GPS) satellites. GPS is a satellite-based radio navigation system run by the United States Department of Defense. GPS is designed so that signals from at least four satellites are available anywhere on earth, which are sufficient to compute the current location of a GPS transceiver, such as GPS transceiver 528.

Cellular system 510 may be, for example, a network of regional, national, or global cellular telephone equipment provided by a public or private telecommunications carrier. The cellular telephone equipment may include, for example, a network of cell towers and/or satellites. Electric vehicle 506 may use cellular system 510 for sending and receiving data, as well as for voice and textual communication purposes. In addition, electric vehicle rental service system 504 may use the network of cellular telephone equipment of cellular system 510 to receive geographic data, such as, for example, current location of electric vehicle 506 if necessary. This geographic data provided by cellular system 510 may provide temporary geographic data input when, for example, data signals from satellite system 508 are not available.

Charging station 512 is a location where a user of electric vehicle 506 may perform an electric vehicle exchange with another electric vehicle user. Charging station 512 may include sensor system 530 and battery charger 532. Sensor system 530 may include a set of weight sensors and/or a set of imaging sensors for determining, for example, objects left behind in an electric vehicle and/or damage to an electric vehicle. Battery charger 532 is a device capable of recharging an electric vehicle battery. Even though in this example charging station 512 includes battery charger 532, a charging station does not have to include a battery charger.

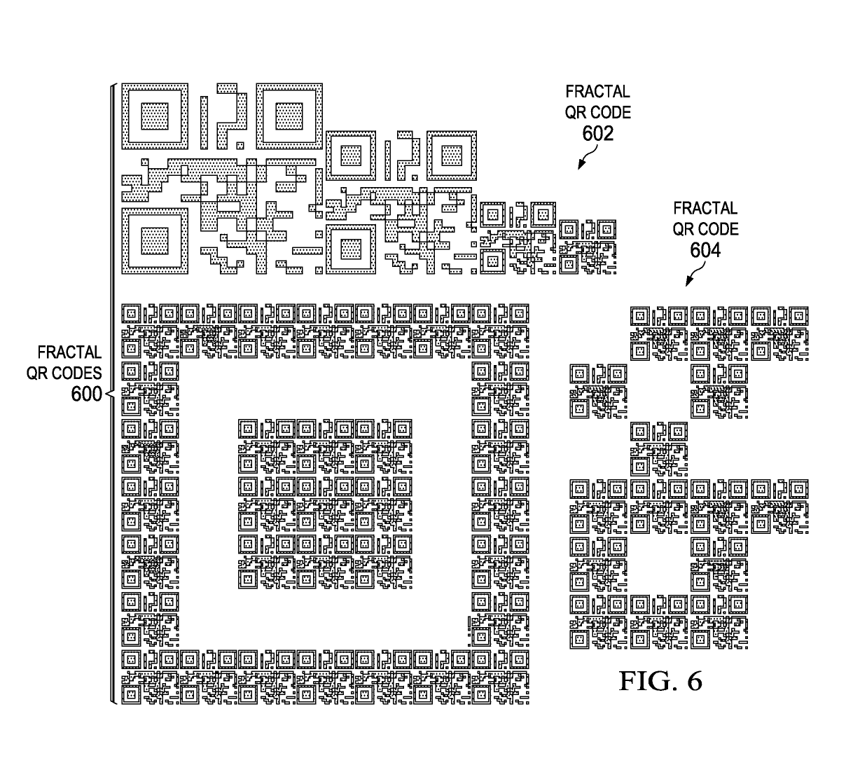

With reference now to FIG. 6, a diagram of example fractal quick response codes is depicted in accordance with an illustrative embodiment. Fractal quick response codes 600 are two examples of fractal quick response codes that may be utilized by different illustrative embodiments. Fractal quick response codes 600 include fractal quick response code 602 and fractal quick response code 604.

Fractal quick response code 602 illustrates similar quick response codes at progressively smaller scales. Fractal quick response code 604 illustrates another type of fractal quick response code, where each pixel is actually composed of a smaller quick response code, to help detect the size scale of damage, dirt, dent, or paint scraping on an electric vehicle, such as electric vehicle 506 in FIG. 5. An electric vehicle rental agency may utilize fractal quick response code 604 as a company identification logo or as a fashion statement, for example.

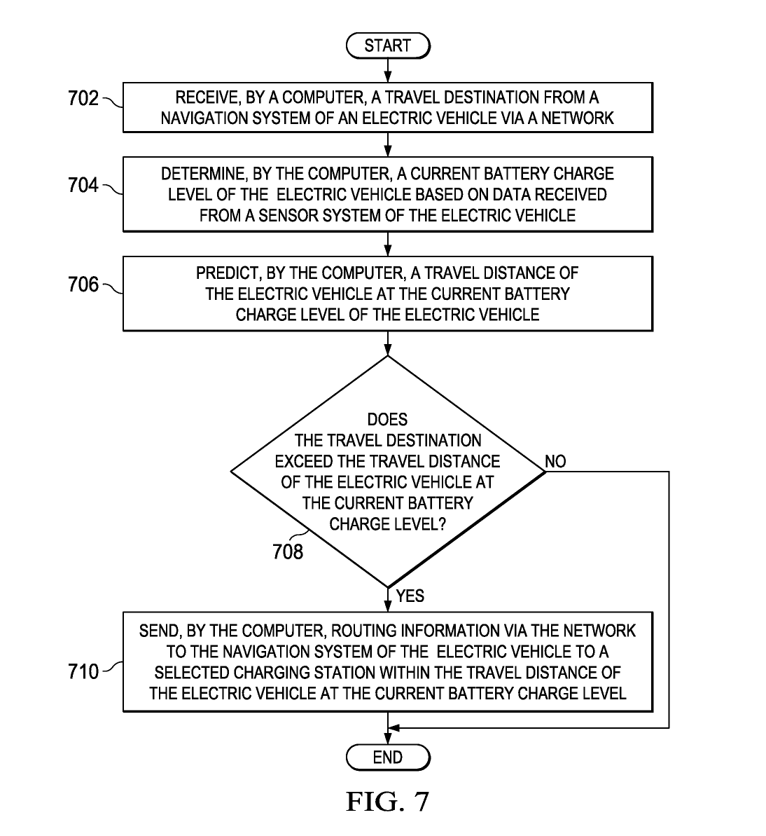

With reference now to FIG. 7, a flowchart illustrating a process for determining whether a travel destination of an electric vehicle exceeds a travel distance of the electric vehicle at a current battery level charge of the electric vehicle is shown in accordance with an illustrative embodiment. The process shown in FIG. 7 may be implemented in a computer, such as, for example, server 104 in FIG. 1 and data processing system 200 in FIGS. 2A-2B.

The process begins when the computer receives a travel destination from a navigation system of an electric vehicle via a network (step 702). The navigation system of the electric vehicle may be, for example, navigation system 520 of electric vehicle 506 in FIG. 5. The network may be, for example, network 502 in FIG. 5.

In addition, the computer determines a current battery charge level of the electric vehicle based on data received from a sensor system of the electric vehicle (step 704). The sensor system of the electric vehicle may be, for example, sensor system 522 in FIG. 5. Further, the computer predicts a travel distance of the electric vehicle at the current battery charge level of the electric vehicle (step 706). The predicted travel distance of the electric vehicle at the current battery charge level may be, for example, predicted travel distance at the current battery charge level 238 in FIG. 2A.

The computer also makes a determination as to whether the travel destination exceeds the travel distance of the electric vehicle at the current battery charge level (step 708). If the computer determines that the travel destination does not exceed the travel distance of the electric vehicle at the current battery charge level, no output of step 708, then the process terminates thereafter. If the computer determines that the travel destination does exceed the travel distance of the electric vehicle at the current battery charge level, yes output of step 708, then the computer sends routing information via the network to the navigation system of the electric vehicle to a selected charging station within the travel distance of the electric vehicle at the current battery charge level (step 710). The selected charging station may be, for example, charging station 512 in FIG. 5. Thereafter, the process terminates.

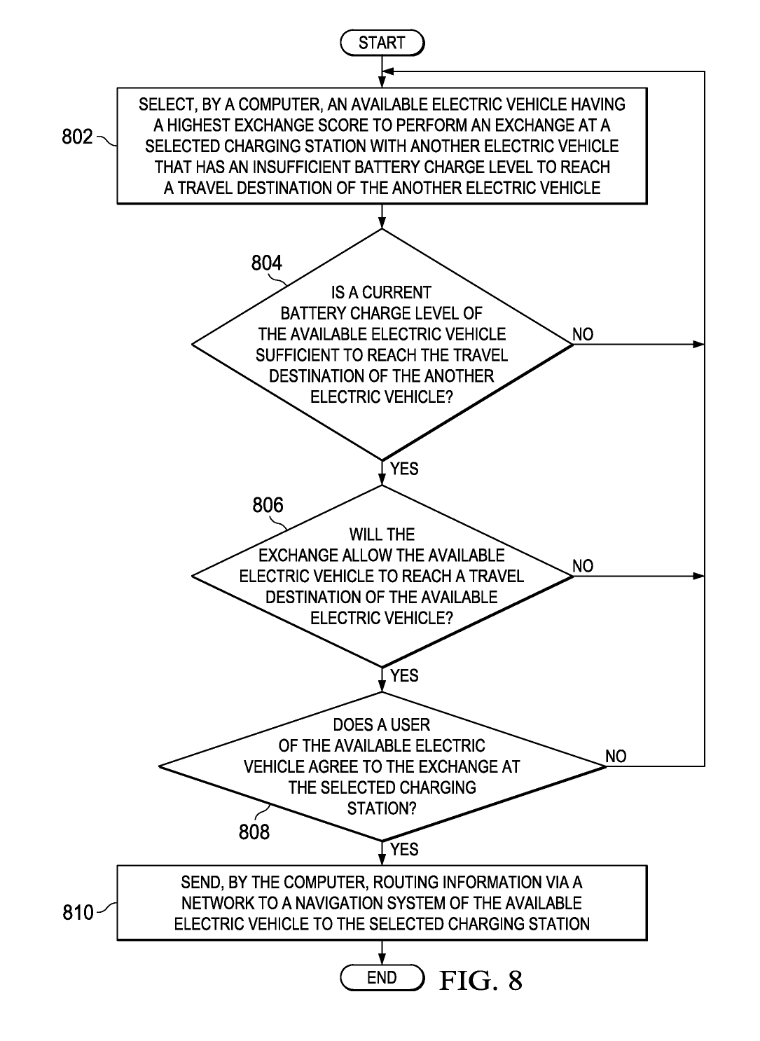

With reference now to FIG. 8, a flowchart illustrating a process for selecting an available electric vehicle to exchange with an electric vehicle having insufficient battery charge to reach its destination is shown in accordance with an illustrative embodiment. The process shown in FIG. 8 may be implemented in a computer, such as, for example, server 104 in FIG. 1 and data processing system 200 in FIGS. 2A-2B.

The process begins when the computer selects an available electric vehicle having a highest exchange score to perform an exchange at a selected charging station with another electric vehicle that has an insufficient battery charge level to reach a travel destination of the another electric vehicle (step 802). The available electric vehicle having the highest exchange score may be, for example, available electric vehicle with highest exchange score 248 in FIG. 2A. The exchange may be either an exchange of electric vehicles or an exchange of electric vehicle batteries. The selected charging station may be, for example, charging station 512 in FIG. 5. The other electric vehicle with an insufficient battery charge level to reach its travel destination may be, for example, electric vehicle 506 in FIG. 5.

In addition, the computer makes a determination as to whether a current battery charge level of the available electric vehicle is sufficient to reach the travel destination of the another electric vehicle (step 804). If the computer determines that the current battery charge level of the available electric vehicle is not sufficient to reach the travel destination of the another electric vehicle, no output of step 804, then the process returns to step 802 where the computer selects another available electric vehicle with a next highest exchange score. If the computer determines that the current battery charge level of the available electric vehicle is sufficient to reach the travel destination of the another electric vehicle, yes output of step 804, then the computer makes a determination as to whether the exchange will allow the available electric vehicle to reach a travel destination of the available electric vehicle (step 806).

If the computer determines that the exchange will not allow the available electric vehicle to reach the travel destination of the available electric vehicle, no output of step 806, then the process returns to step 802 where the computer selects another available electric vehicle. If the computer determines that the exchange will allow the available electric vehicle to reach the travel destination of the available electric vehicle, yes output of step 806, then the computer makes a determination as to whether a user of the available electric vehicle agrees to the exchange at the selected charging station (step 808).

If the computer determines that the user of the available electric vehicle does not agree to the exchange at the selected charging station, no output of step 808, then the process returns to step 802 where the computer selects another available electric vehicle. If the computer determines that the user of the available electric vehicle does agree to the exchange at the selected charging station, yes output of step 808, then the computer sends routing information via a network to a navigation system of the available electric vehicle to the selected charging station (step 810). Thereafter, the process terminates.

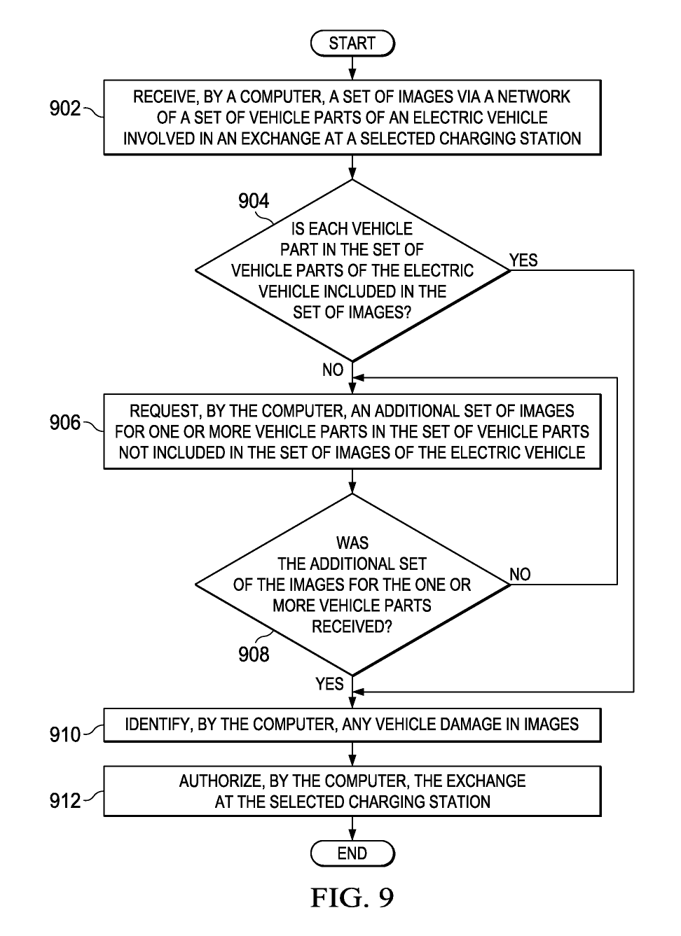

With reference now to FIG. 9, a flowchart illustrating a process for identifying damage to an electric vehicle prior to an exchange is shown in accordance with an illustrative embodiment. The process shown in FIG. 9 may be implemented in a computer, such as, for example, server 104 in FIG. 1 and data processing system 200 in FIGS. 2A-2B.

The process begins when the computer receives a set of images via a network of a set of vehicle parts of an electric vehicle involved in an exchange at a selected charging station (step 902). Afterward, the computer makes a determination as to whether each vehicle part in the set of vehicle parts of the electric vehicle is included in the set of images (step 904). If the computer determines that each vehicle part in the set of vehicle parts of the electric vehicle is included in the set of images, yes output of step 904, then the process proceeds to step 910. If the computer determines that each vehicle part in the set of vehicle parts of the electric vehicle is not included in the set of images, no output of step 904, then the computer requests an additional set of images for one or more vehicle parts in the set of vehicle parts not included in the set of images of the electric vehicle (step 906).

Subsequently, the computer makes a determination as to whether the additional set of images for the one or more vehicle parts was received (step 908). If the computer determines that the additional set of images for the one or more vehicle parts was not received, no output of step 908, then the process returns to step 906 where the computer continues to request the additional set of images. If the computer determines that the additional set of images for the one or more vehicle parts was received, yes output of step 908, then the computer identifies any vehicle damage in images (step 910). The computer also authorizes the exchange at the selected charging station (step 912). Thereafter, the process terminates.

Thus, illustrative embodiments of the present invention provide a computer-implemented method, computer system, and computer program product for managing an exchange of an electric vehicle having an insufficient battery charge to reach a user desired destination with another electric vehicle that has sufficient battery charge to reach the user desired destination. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for managing an electric vehicle exchange, the computer-implemented method comprising:
selecting, by a computer, an available electric vehicle having a highest exchange score to perform an exchange at a selected charging station with another electric vehicle that has an insufficient battery charge level to reach a travel destination of the another electric vehicle;
responsive to the computer determining that a current battery charge level of the available electric vehicle is sufficient to reach the travel destination of the another electric vehicle, determining, by the computer, whether the exchange will allow the available electric vehicle to reach a travel destination of the available electric vehicle; and
responsive to the computer determining that the exchange will allow the available electric vehicle to reach the travel destination of the available electric vehicle, sending, by the computer, routing information via a network to a navigation system of the available electric vehicle to the selected charging station.

2. The computer-implemented method of claim 1, wherein the computer performs the selecting of the available electric vehicle and selecting a geographic location for the exchange using at least one order embedding algorithm among an elastic map, a Sammon's map, and a Kohonen map.

3. The computer-implemented method of claim 1 further comprising:
determining, by the computer, whether a user of the available electric vehicle agrees to the exchange at the selected charging station.

4. The computer-implemented method of claim 1 further comprising:
receiving, by the computer, the travel destination from a navigation system of the another electric vehicle via the network;
determining, by the computer, a current battery charge level of the another electric vehicle based on data received from a sensor system of the another electric vehicle; and
predicting, by the computer, a travel distance of the another electric vehicle at the current battery charge level of the another electric vehicle.

5. The computer-implemented method of claim 4 further comprising:
determining, by the computer, whether the travel destination of the another electric vehicle exceeds the travel distance of the another electric vehicle at the current battery charge level of the another electric vehicle; and
responsive to the computer determining that the travel destination of the another electric vehicle exceeds the travel distance of the another electric vehicle at the current battery charge level of the another electric vehicle, sending, by the computer, the routing information via the network to a navigation system of the another electric vehicle to the selected charging station within the travel distance of the another electric vehicle at the current battery charge level.

6. The computer-implemented method of claim 1 further comprising:
receiving, by the computer, a set of images via the network of a set of vehicle parts of the available electric vehicle and the another electric vehicle involved in the exchange at the selected charging station.

7. The computer-implemented method of claim 6 further comprising:
determining, by the computer, whether each vehicle part in the set of vehicle parts of the available electric vehicle and the another electric vehicle is included in the set of images;
identifying, by the computer, any vehicle damage in the set of images; and
authorizing, by the computer, the exchange at the selected charging station.

8. The computer-implemented method of claim 5, wherein each vehicle part in the set of vehicle parts of the available electric vehicle and the another electric vehicle include a quick response code.

9. The computer-implemented method of claim 8, wherein the quick response code is a fractal quick response code.

10. The computer-implemented method of claim 1, wherein the computer utilizes an object detection module to identify objects onboard the available electric vehicle and the another electric vehicle to facilitate the exchange.

11. The computer-implemented method of claim 1, wherein the computer utilizes a routing module to automatically estimate in real time travel routes for the available electric vehicle and the another electric vehicle to the selected charging station using GPS localization and a Bayesian model of routes that users of the available electric vehicle and the another electric vehicle are likely to take given current contexts and locations and what travel routes other users have previously taken to reach the selected charging station.

12. A computer system for managing an electric vehicle exchange, the computer system comprising:
a bus system;
a storage device connected to the bus system, wherein the storage device stores program instructions; and
a processor connected to the bus system, wherein the processor executes the program instructions to select an available electric vehicle having a highest exchange score to perform an exchange at a selected charging station with another electric vehicle that has an insufficient battery charge level to reach a travel destination of the another electric vehicle; determine whether the exchange will allow the available electric vehicle to reach a travel destination of the available electric vehicle in response to determining that a current battery charge level of the available electric vehicle is sufficient to reach the travel destination of the another electric vehicle; and send routing information via a network to a navigation system of the available electric vehicle to the selected charging station in response to determining that the exchange will allow the available electric vehicle to reach the travel destination of the available electric vehicle.

13. The computer system of claim 12, wherein the processor further executes the program instructions to perform selecting of the available electric vehicle and selecting a geographic location for the exchange using at least one order embedding algorithm among an elastic map, a Sammon's map, and a Kohonen map.

14. A computer program product for managing an electric vehicle exchange, the computer program product comprising a computer readable storage medium having program instructions embodied therewith, the program instructions executable by a computer to cause the computer to perform a method comprising:
selecting, by the computer, an available electric vehicle having a highest exchange score to perform an exchange at a selected charging station with another electric vehicle that has an insufficient battery charge level to reach a travel destination of the another electric vehicle;
responsive to the computer determining that a current battery charge level of the available electric vehicle is sufficient to reach the travel destination of the another electric vehicle, determining, by the computer, whether the exchange will allow the available electric vehicle to reach a travel destination of the available electric vehicle; and
responsive to the computer determining that the exchange will allow the available electric vehicle to reach the travel destination of the available electric vehicle, sending, by the computer, routing information via a network to a navigation system of the available electric vehicle to the selected charging station.

15. The computer program product of claim 14, wherein the computer performs the selecting of the available electric vehicle and selecting a geographic location for the exchange using at least one order embedding algorithm among an elastic map, a Sammon's map, and a Kohonen map.

16. The computer program product of claim 14 further comprising:
determining, by the computer, whether a user of the available electric vehicle agrees to the exchange at the selected charging station.

17. The computer program product of claim 14 further comprising:
receiving, by the computer, the travel destination from a navigation system of the another electric vehicle via the network;
determining, by the computer, a current battery charge level of the another electric vehicle based on data received from a sensor system of the another electric vehicle; and
predicting, by the computer, a travel distance of the another electric vehicle at the current battery charge level of the another electric vehicle.

18. The computer program product of claim 17 further comprising:
determining, by the computer, whether the travel destination of the another electric vehicle exceeds the travel distance of the another electric vehicle at the current battery charge level of the another electric vehicle; and
responsive to the computer determining that the travel destination of the another electric vehicle exceeds the travel distance of the another electric vehicle at the current battery charge level of the another electric vehicle, sending, by the computer, the routing information via the network to a navigation system of the another electric vehicle to the selected charging station within the travel distance of the another electric vehicle at the current battery charge level.

19. The computer program product of claim 14 further comprising:
receiving, by the computer, a set of images via the network of a set of vehicle parts of the available electric vehicle and the another electric vehicle involved in the exchange at the selected charging station.

20. The computer program product of claim 19 further comprising:
determining, by the computer, whether each vehicle part in the set of vehicle parts of the available electric vehicle and the another electric vehicle is included in the set of images;
identifying, by the computer, any vehicle damage in the set of images; and
authorizing, by the computer, the exchange at the selected charging station.
